(19) United States
(12) Patent Application Publication
(10) Pub. No.: US 2014/0272200 A1
(43) Pub. Date: Sep. 18, 2014

(54) PRESSURE-SENSITIVE ADHESIVE LAYER-ATTACHED POLARIZING FILM AND IMAGE DISPLAY DEVICE

(71) Applicant: NITTO DENKO CORPORATION, Osaka (JP)

(72) Inventors: Shinsuke Akizuki, Ibaraki-shi (JP); Atsushi Yasui, Ibaraki-shi (JP); Yuusuke Toyama, Ibaraki-shi (JP); Takaaki Ishii, Ibaraki-shi (JP)

(73) Assignee: NITTO DENKO CORPORATION, Osaka (JP)

(21) Appl. No.: 14/197,470

(22) Filed: Mar. 5, 2014

(30) Foreign Application Priority Data
Mar. 13, 2013 (JP) 2013-050694

(51) Int. Cl. C09J 7/02; G02F 1/1335

(52) U.S. Cl. CPC C09J 7/0217; C09J 7/0246; G02F 1/133528
USPC 428/1.54; 428/334; 428/336

(57) ABSTRACT

A pressure-sensitive adhesive layer-attached polarizing film contains a polarizing film containing a polarizer and a transparent protective film provided on at least one side of the polarizer, the polarizing film having a total thickness of 100 μm or less. A pressure-sensitive adhesive layer is provided on the polarizing film and made from a pressure-sensitive adhesive composition containing a (meth)acryl-based polymer and an antioxidant.

### BACKGROUND OF THE INVENTION

1. Field of the Invention

The present invention relates to a pressure-sensitive adhesive layer-attached polarizing film. The present invention also relates to an image display device, such as a liquid crystal display device, an organic electroluminescent (EL) display device, or a plasma display panel (PDP), formed using the pressure-sensitive adhesive layer-attached polarizing film.

2. Description of the Related Art

Some image display devices have an image-forming mechanism including polarizing elements placed as essential components on both sides of a liquid crystal cell, and generally, polarizing films are attached as the polarizing elements. A pressure-sensitive adhesive is generally used to bond such polarizing films to a liquid crystal cell. When such polarizing films are bonded to a liquid crystal cell, a pressure-sensitive adhesive is generally used to bond the materials together so that optical loss can be reduced. In such a case, the pressure-sensitive adhesive is provided in advance as a pressure-sensitive adhesive layer on one side of a polarizing film, and the resulting pressure-sensitive adhesive layer-attached polarizing film is generally used because it has some advantages such as no need for a drying process to fix the polarizing film.

A recent trend of image display devices for mobile applications such as cellular phones is a reduction in the thickness and weight of the whole of the module particularly for designability or portability. Polarizing films for use in image display devices also need to be thinner and lighter. On the other hand, image display devices have come to be used in various environments including harsh outdoor environments, and need to be more durable than ever. Under these circumstances, thinner polarizing films with excellent optical properties are needed, and there is also a need to develop pressure-sensitive adhesive layers suitable for use on such thinner polarizing films.

There are reported techniques of adding an antioxidant to a pressure-sensitive adhesive layer so that a pressure-sensitive adhesive layer-attached polarizing film with improved durability and other properties can be formed. For example, Patent Document 1 listed below describes a pressure-sensitive adhesive composition containing a (meth)acrylic ester copolymer with a weight average molecular weight of 500,000 to 2,500,000, a crosslinking agent, a radical scavenger, and a secondary antioxidant including a phosphorus-containing antioxidant or a sulfur-containing antioxidant. Patent Document 2 listed below describes a pressure-sensitive adhesive for use on optical films, the pressure-sensitive adhesive including: a polymer containing a (meth)acrylic ester as a main component; an antioxidant; and a crosslinking agent, having a gel fraction of 30 to 60%, and containing a sol component in which the content of a polymer component with a molecular weight of 10,000 or less is 25% by weight or more as measured by GPC. Patent Document 3 listed below describes an acrylic pressure-sensitive adhesive composition including: 100 parts by weight of an acrylic copolymer containing a C1 to C12 alkyl(meth)acrylate as a main component and having a weight average molecular weight (Mw) of 500,000 or more and a ratio (Mw/Mn) of weight average molecular weight to number average molecular weight of 4.0 or less; 0.001 to 5 parts by weight of at least one crosslinking agent selected from the group consisting of a polyfunctional compound, an organometallic compound, and a metal salt; and 0.01 to 5 parts by weight of an organic phosphite compound. Patent Document 4 listed below describes a pressure-sensitive adhesive-type optical film including a transparent base film, an optical compensation liquid crystal layer provided on one side of the base film, and a pressure-sensitive adhesive layer provided on the liquid crystal layer with an undercoat layer interposed therebetween, wherein the undercoat layer contains polymers and an antioxidant.

### PRIOR ART DOCUMENTS

### Patent Documents

Patent Document 1: Japanese Patent No. 4838926
Patent Document 2: JP-A-2003-49143
Patent Document 3: JP-A-08-157795
Patent Document 4: JP-A-2008-176270

### SUMMARY OF THE INVENTION

Now, thin polarizing films have a wide variety of applications and need to be highly durable even in high-temperature and/or high-humidity environments. As a result of careful study, the present inventors have found that as the thickness of a pressure-sensitive adhesive layer-attached thin polarizing film decreases, it becomes easily deformable during long-time storage in a high-temperature and/or high-humidity environment. Specifically, with respect to such deformation, it has been concluded that particularly as its thickness decreases, its polarizer and/or its transparent protective film becomes easily shrinkable so that peeling or foaming can occur at the end of its pressure-sensitive adhesive layer to cause deformation. As discussed above, it has been found that the decrease in the thickness of a pressure-sensitive adhesive layer-attached polarizing film causes its own problem, and thus there is a need to solve such a problem.

Unfortunately, the disclosures of Patent Documents 1 to 3 are silent on the decrease in the thickness of polarizing films, specifically, silent on thin polarizing films, and do not suggest the unique problem caused by the decrease in the thickness of pressure-sensitive adhesive layer-attached polarizing films.

The disclosure of Patent Document 4 is also silent on thin polarizing films and does not disclose or suggest adding an antioxidant to a pressure-sensitive adhesive layer because the disclosure is characterized by adding an antioxidant to an undercoat layer.

An object of the present invention is to provide a pressure-sensitive adhesive layer-attached polarizing film in which the end of the polarizing film is prevented from having a defective appearance, which is the unique problem caused by the decrease in the thickness of pressure-sensitive adhesive layer-attached polarizing films.

Another object of the present invention is to provide an image display device formed using such a pressure-sensitive adhesive layer-attached polarizing film.

As a result of intensive studies to solve the problems, the present inventors have found that when the pressure-sensitive adhesive layer of a pressure-sensitive adhesive layer-attached thin polarizing film is made from a pressure-sensitive adhesive composition containing an antioxidant, (1) oxidation-induced cleavage of the main chain of a (meth)acryl-based polymer can be prevented at the end of the pressure-sensitive adhesive layer, and (2) the pressure-sensitive adhesive can have sufficient adhesive strength at the end even though a strong shrinkage-deformation force acts on the thin polarizer and/or the thin transparent protective film. As a result, the present inventors have found that even when the total thickness of the polarizing film is reduced to 100 μm or less, the antioxidant present in the pressure-sensitive adhesive layer can prevent the end of the pressure-sensitive adhesive layer-attached polarizing film from having a defective appearance. The present invention, which has been accomplished as a result of these studies, may have the features described below.

Specifically, the present invention is directed to a pressure-sensitive adhesive layer-attached polarizing film, including: a polarizing film including a polarizer and a transparent protective film provided on at least one side of the polarizer, the polarizing film having a total thickness of 100 μm or less; and a pressure-sensitive adhesive layer provided on the polarizing film and made from a pressure-sensitive adhesive composition containing a (meth)acryl-based polymer and an antioxidant.

In the pressure-sensitive adhesive layer-attached polarizing film, the polarizer preferably has a thickness of 10 μm or less.

In the pressure-sensitive adhesive layer-attached polarizing film, the pressure-sensitive adhesive composition preferably contains 0.005 to 2 parts by weight of the antioxidant based on 100 parts by weight of the (meth)acryl-based polymer.

In the pressure-sensitive adhesive layer-attached polarizing film, the pressure-sensitive adhesive composition preferably contains a crosslinking agent.

In the pressure-sensitive adhesive layer-attached polarizing film, the pressure-sensitive adhesive composition preferably contains a peroxide as the crosslinking agent, preferably contains an isocyanate crosslinking agent, or preferably contains both a peroxide and an isocyanate crosslinking agent.

In the pressure-sensitive adhesive layer-attached polarizing film, the pressure-sensitive adhesive composition preferably contains 0.01 to 20 parts by weight of the crosslinking agent based on 100 parts by weight of the (meth)acryl-based polymer.

In the pressure-sensitive adhesive layer-attached polarizing film, the antioxidant is preferably a phenolic antioxidant.

In the pressure-sensitive adhesive layer-attached polarizing film, the (meth)acryl-based polymer preferably contains monomer units derived from an alkyl(meth)acrylate and a hydroxyl group-containing monomer.

In the pressure-sensitive adhesive layer-attached polarizing film, the (meth)acryl-based polymer preferably contains monomer units derived from an alkyl(meth)acrylate and a carboxyl group-containing monomer.

In the pressure-sensitive adhesive layer-attached polarizing film, the (meth)acryl-based polymer preferably has a weight average molecular weight of 500,000 to 3,000,000.

In the pressure-sensitive adhesive layer-attached polarizing film, the pressure-sensitive adhesive composition preferably further contains 0.001 to 5 parts by weight of a silane coupling agent based on 100 parts by weight of the (meth)acryl-based polymer.

The present invention is also directed to an image display device including at least one piece of the pressure-sensitive adhesive layer-attached polarizing film having any of the features set forth above.

According to the present invention, the antioxidant present in the pressure-sensitive adhesive composition used to form the pressure-sensitive adhesive layer can prevent the end of the polarizing film from having a defective appearance even when the pressure-sensitive adhesive layer-attached polarizing film is a thin type in which the polarizing film has a total thickness of 100 μm or less.

In addition, when the pressure-sensitive adhesive composition used to form the pressure-sensitive adhesive layer contains a crosslinking agent and particularly when it contains a peroxide as the crosslinking agent, the antioxidant can effectively suppress oxygen-induced inhibition of radical crosslinking, so that three-dimensionally crosslinked networks can be efficiently formed in the pressure-sensitive adhesive layer. In other words, when the antioxidant and the crosslinking agent, particularly, a combination of the antioxidant and a peroxide are present in the pressure-sensitive adhesive composition used to form the pressure-sensitive adhesive layer, the end of the polarizing film can be more effectively prevented from having a defective appearance.

### DETAILED DESCRIPTION OF THE PREFERRED EMBODIMENTS

The pressure-sensitive adhesive layer-attached polarizing film of the present invention includes a polarizing film and a pressure-sensitive adhesive layer formed on at least one side of the polarizing film. In the present invention, to meet the need for a thinner pressure-sensitive adhesive layer-attached polarizing film, the polarizing film has a total thickness of 100 μm or less, preferably 70 μm or less, more preferably 50 μm or less. For example, the lower limit of the total thickness of the polarizing film is typically, but not limited to, 10 μm.

The pressure-sensitive adhesive layer is made from a pressure-sensitive adhesive composition as a raw material. The pressure-sensitive adhesive composition contains a (meth)acryl-based polymer as a base polymer. The (meth)acryl-based polymer contains, as a main component, a monomer unit derived from an alkyl(meth)acrylate. As used herein, the term “(meth)acrylate” refers to acrylate and/or methacrylate, and “(meth)” is used in the same meaning in the description.

An alkyl(meth)acrylate may be used to form the main skeleton of the (meth)acryl-based polymer. For example, such an alkyl(meth)acrylate may have a linear or branched alkyl group of 1 to 18 carbon atoms. For example, such an alkyl group may be methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, octadecyl, or the like. These groups may be used alone or in any combination. Such alkyl groups preferably have an average number of carbon atoms of 3 to 9.

The (meth)acryl-based polymer preferably contains a monomer unit derived from a hydroxyl group-containing monomer, such as 2-hydroxyethyl(meth)acrylate, 3-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, or (4-hydroxymethylcyclohexyl)methyl acrylate. The weight content of the hydroxyl group-containing monomer in all monomers (100% by weight) used to form the (meth)acryl-based polymer is preferably from 1 to 10% by weight, more preferably from 3 to 7% by weight.

Among them, 4-hydroxybutyl acrylate is particularly advantageous in efficiently forming crosslink points with isocyanate groups specifically when an isocyanate crosslinking agent is used.

An aromatic ring-containing alkyl(meth)acrylate such as phenoxyethyl(meth)acrylate or benzyl(meth)acrylate may also be used for pressure-sensitive adhesive properties, durability, control of retardation, control of refractive index, or other purposes. The aromatic ring-containing alkyl(meth)acrylate may be used to produce a polymer for use in mixing with the (meth)acryl-based polymer mentioned above. In view of transparency, however, the aromatic ring-containing alkyl(meth)acrylate is preferably used together with the above alkyl(meth)acrylate to produce a copolymer.

Concerning the (meth)acryl-based polymer, the content of the aromatic ring-containing alkyl(meth)acrylate in all monomers (100% by weight) used to form the hydroxyl group-containing (meth)acryl-based polymer (A) may be 50% by weight or less. The content of the aromatic ring-containing alkyl(meth)acrylate is preferably from 1 to 35% by weight, more preferably from 5 to 30% by weight, even more preferably from 10 to 25% by weight.

To improve tackiness or heat resistance, one or more copolymerizable monomers having an unsaturated double bond-containing polymerizable functional group such as a (meth)acryloyl group or a vinyl group may be introduced into the (meth)acryl-based polymer by copolymerization. Examples of such copolymerizable monomers include carboxyl group-containing monomers such as (meth)acrylic acid, carboxyethyl(meth)acrylate, carboxypentyl(meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl(meth)acrylate, and (meth)acryloyloxynaphthalenesulfonic acid; and phosphate group-containing monomers such as 2-hydroxyethylacryloyl phosphate.

Examples of such monomers for modification also include (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl(meth)acrylate monomers such as aminoethyl(meth)acrylate, N,N-dimethylaminoethyl(meth)acrylate, and tert-butylaminoethyl(meth)acrylate; alkoxyalkyl(meth)acrylate monomers such as methoxyethyl(meth)acrylate and ethoxyethyl(meth)acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modifying monomers that may also be used include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl(meth)acrylate; glycol acrylate monomers such as polyethylene glycol(meth)acrylate, polypropylene glycol(meth)acrylate, methoxyethylene glycol(meth)acrylate, and methoxypolypropylene glycol(meth)acrylate; and acrylic ester monomers such as tetrahydrofurfuryl(meth)acrylate, fluoro(meth)acrylate, silicone(meth)acrylate, and 2-methoxyethyl acrylate. Examples also include isoprene, butadiene, isobutylene, vinyl ether, etc.

Copolymerizable monomers other than the above include silane monomers containing a silicon atom. Examples of such silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Examples of copolymerizable monomers that may also be used include polyfunctional monomers having two or more unsaturated double bonds such as those in (meth)acryloyl groups or vinyl groups, which include (meth)acrylic esters of polyhydric alcohols, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and polyester(meth)acrylates, epoxy(meth)acrylates, urethane(meth)acrylates, or other compounds having a polyester, epoxy, or urethane skeleton, to which two or more unsaturated double bonds are added in the form of functional groups such as (meth)acryloyl groups or vinyl groups in the same manner as the constituent monomers.

Concerning the weight contents of all monomers used to form the (meth)acryl-based polymer, the alkyl(meth)acrylate should be a main component, and the content of the copolymerizable monomer is preferably, but not limited to, 0 to about 20%, more preferably about 0.1 to about 15%, even more preferably about 0.1 to about 10%, based on the total weight of all monomers used to form the (meth)acryl-based polymer.

Among these copolymerizable monomers, carboxyl group-containing monomers are preferably used in view of tackiness or durability. When the pressure-sensitive adhesive composition contains a crosslinking agent, carboxyl group-containing monomers can serve as reactive sites to the crosslinking agent. Such carboxyl group-containing monomers are highly reactive with intermolecular crosslinking agents and therefore are preferably used to improve the cohesiveness or heat resistance of the resulting pressure-sensitive adhesive layer. Carboxyl group-containing monomers are advantageous in providing both durability and reworkability.

When a carboxyl group-containing monomer is added as a copolymerizable monomer, the content thereof is preferably from 0.05 to 10% by weight, more preferably from 0.1 to 8% by weight, even more preferably from 0.2 to 6% by weight.

In the present invention, the (meth)acryl-based polymer used preferably has a weight average molecular weight in the range of 500,000 to 3,000,000. In view of durability, particularly, heat resistance, the (meth)acryl-based polymer used preferably has a weight average molecular weight of 1,000,000 to 2,700,000. It more preferably has a weight average molecular weight of 1,300,000 to 2,500,000. A weight average molecular weight of less than 500,000 is not preferred in view of heat resistance. If the weight average molecular weight is more than 3,000,000, a large amount of a diluent solvent can be necessary for adjusting the viscosity to be suitable for coating, which may increase cost and is not preferred. The weight average molecular weight refers to a polystyrene-equivalent molecular weight as measured and calculated using gel permeation chromatography (GPC).

The (meth)acryl-based polymer described above can be produced by a method appropriately selected from known methods such as solution polymerization, bulk polymerization, emulsion polymerization, and various types of radial polymerization. The resulting (meth)acryl-based polymer may be a random copolymer, a block copolymer, a graft copolymer, or any other form.

In solution polymerization, for example, ethyl acetate, toluene, or the like may be used as a polymerization solvent. An example of solution polymerization includes performing the reaction under a stream of inert gas such as nitrogen in the presence of a polymerization initiator typically under the reaction conditions of a temperature of about 50 to about 70° C. and a time period of about 5 to about 30 hours.

Any appropriately selected polymerization initiator, chain transfer agent, emulsifier, or other agents may be used for radical polymerization. The weight average molecular weight of the (meth)acryl-based polymer can be adjusted by controlling the amount of the polymerization initiator or the chain transfer agent or by controlling the reaction conditions. The amount of these agents may be adjusted as appropriate depending on the type of these agents.

Examples of the polymerization initiator include, but are not limited to, azo initiators such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057 manufactured by Wako Pure Chemical Industries, Ltd.); persulfates such as potassium persulfate and ammonium persulfate; peroxide initiators such as di(2-ethylhexyl) peroxydicarbonate, di(4-tert-butylcyclohexyl) peroxydicarbonate, di-sec-butyl peroxydicarbonate, tert-butyl peroxyneodecanoate, tert-hexyl peroxypivalate, tert-butyl peroxypivalate, dilauroyl peroxide, di-n-octanoyl peroxide, 1,1,3,3-tetramethylbutylperoxy-2-ethyl hexanoate, di(4-methylbenzoyl)peroxide, dibenzoyl peroxide, tert-butyl peroxyisobutyrate, 1,1-di(tert-hexylperoxy)cyclohexane, tert-butyl hydroperoxide, and hydrogen peroxide; and a redox system initiator including a combination of a peroxide and a reducing agent, such as a combination of a persulfate and sodium hydrogen sulfite or a combination of a peroxide and sodium ascorbate.

The above polymerization initiators may be used alone or in combination of two or more. The total content of the polymerization initiator(s) is preferably from about 0.005 to about 1 part by weight, more preferably from about 0.02 to about 0.5 parts by weight, based on 100 parts by weight of the monomers.

For example, when the hydroxyl group-containing (meth)acryl-based polymer (A) with a weight average molecular weight as shown above is produced using 2,2′-azobisisobutyronitrile as a polymerization initiator, the amount of the polymerization initiator is preferably from about 0.06 to about 0.2 parts by weight, more preferably from about 0.08 to about 0.175 parts by weight, based on 100 parts by weight of all monomers.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. The chain transfer agents may be used alone or in combination of two or more. The total content of the chain transfer agent(s) should be about 0.1 parts by weight or less, based on 100 parts by weight of all monomers.

Examples of the emulsifier for use in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone or in combination of two or more.

The emulsifier may be a reactive emulsifier. Examples of such an emulsifier having an introduced radically-polymerizable functional group, such as a propenyl group or an allyl ether group, include AQUALON HS-10, HS-20, KH-10, BC-05, BC-10, and BC-20 (all manufactured by DAI-ICHI KOGYO SEIYAKU CO., Ltd.) and ADEKA REASOAP SE10N (manufactured by ADEKA CORPORATION). The reactive emulsifier is preferred, because after polymerization, it can improve water resistance by being incorporated in the polymer chain. Based on 100 parts by weight of all monomers, the emulsifier is preferably used in an amount of 0.3 to 5 parts by weight, more preferably 0.5 to 1 part by weight, in view of polymerization stability or mechanical stability.

An antioxidant is contained in the pressure-sensitive adhesive composition from which the pressure-sensitive adhesive layer is made. Examples of the antioxidant include a phenolic antioxidant, a phosphorus-containing antioxidant, a sulfur-containing antioxidant, and an amine antioxidant. At least one selected from these antioxidants may be used. Among them, a phenolic antioxidant is preferred.

Examples of the phenolic antioxidant include monocyclic phenol compounds such as 2,6-di-tert-butyl-p-cresol, 2,6-di-tert-butyl-4-ethylphenol, 2,6-dicyclohexyl-4-methylphenol, 2,6-diisopropyl-4-ethylphenol, 2,6-di-tert-amyl-4-methylphenol, 2,6-di-tert-octyl-4-n-propylphenol, 2,6-dicyclohexyl-4-n-octylphenol, 2-isopropyl-4-methyl-6-tert-butylphenol, 2-tert-butyl-4-ethyl-6-tert-octylphenol, 2-isobutyl-4-ethyl-6-tert-hexylphenol, 2-cyclohexyl-4-n-butyl-6-isopropylphenol, styrenated mixed cresol, DL-α-tocopherol, and stearyl β-(3,5-di-tert-butyl-4-hydroxyphenyl)propionate; bicyclic phenol compounds such as 2,2′-methylenebis(4-methyl-6-tert-butylphenol), 4,4′-butylidenebis(3-methyl-6-tert-butylphenol), 4,4′-thiobis(3-methyl-6-tert-butylphenol), 2,2′-thiobis(4-methyl-6-tert-butylphenol), 4,4′-methylenebis(2,6-di-tert-butylphenol), 2,2′-methylenebis[6-(1-methylcyclohexyl)-p-cresol], 2,2′-ethylidenebis(4,6-di-tert-butylphenol), 2,2′-butylidenebis(2-tert-butyl-4-methylphenol), 3,6-dioxaoctamethylenebis[3-(3-tert-butyl-4-hydroxy-5-methylphenyl)propionate], triethylene glycol bis[3-(3-tert-butyl-5-methyl-4-hydroxyphenyl)propionate], 1,6-hexanediol bis[3-(3,5-di-tert-butyl-4-hydroxyphenyl)propionate], and 2,2′-thiodiethylenebis[3-(3,5-di-tert-butyl-4-hydroxyphenyl)propionate]; tricyclic phenol compounds such as 1,1,3-tris(2-methyl-4-hydroxy-5-tert-butylphenyl)butane, 1,3,5-tris(2,6-dimethyl-3-hydroxy-4-tert-butylbenzyl)isocyanurate, 1,3,5-tris[(3,5-di-tert-butyl-4-hydroxyphenyl)propionyloxyethyl]isocyanurate, tris(4-tert-butyl-2,6-dimethyl-3-hydroxybenzyl)isocyanurate, and 1,3,5-trimethyl-2,4,6-tris(3,5-di-tert-butyl-4-hydroxybenzyl)benzene; tetracyclic phenol compounds such as tetrakis[methylene-3-(3,5-di-tert-butyl-4-hydroxyphenyl)propionate]methane; and phosphorus-containing phenol compounds such as calsium bis(ethyl 3,5-di-tert-butyl-4-hydroxybenzylphosphonate) and nickel bis(ethyl 3,5-di-tert-butyl-4-hydroxybenzylphosphonate).

Examples of the phosphorus-containing antioxidant include trioctyl phosphite, trilauryl phosphite, tristridecyl phosphite, trisisodecyl phosphite, phenyl diisooctyl phosphite, phenyl diisodecyl phosphite, phenyl di(tridecyl) phosphite, diphenyl isooctyl phosphite, diphenyl isodecyl phosphite, diphenyl tridecyl phosphite, triphenyl phosphite, tris(nonylphenyl)phosphite, tris(2,4-di-tert-butylphenyl) phosphite, tris(butoxyethyl)phosphite, tetratridecyl-4,4′-butylidenebis(3-methyl-6-tert-butylphenol)diphosphite, 4,4′-isopropylidene-diphenol alkyl phosphite (wherein the alkyl group has about 12 to about 15 carbon atoms), 4,4′-isopropylidenebis(2-tert-butylphenol)di(nonylphenyl) phosphite, tris(biphenyl)phosphite, tetra(tridecyl)-1,1,3-tris(2-methyl-5-tert-butyl-4-hydroxyphenyl)butane diphosphite, tris(3,5-di-tert-butyl-4-hydroxyphenyl)phosphite, hydrogenated 4,4′-isopropylidenediphenol polyphosphite, bis(octylphenyl)bis[4,4′-butylidenebis(3-methyl-6-tert-butylphenol)]1,6-hexanediol diphosphite, hexatridecyl-1,1,3-tris(2-methyl-4-hydroxy-5-tert-butylphenol)diphosphite, tris[4,4′-isopropylidenebis(2-tert-butylphenol)]phosphite, tris(1,3-distearoyloxyisopropyl)phosphite, 9,10-dihydro-9-phosphaphenanthrene-10-oxide, tetrakis(2,4-di-tert-butylphenyl)-4,4′-biphenylene diphosphonite, distearyl pentaerythritol diphosphite, di(nonylphenyl)pentraerythritol diphosphite, phenyl 4,4′-isopropylidenediphenol pentaerythritol diphosphite, bis(2,4-di-tert-butylphenyl)pentaerythritol diphosphite, bis(2,6-di-tert-butyl-4-methylphenyl)pentaerythritol diphosphite, and phenylbisphenol-A-pentaerythritol diphosphite.

Examples of the sulfur-containing antioxidant which are preferably used include dialkyl thiodipropionates and polyhydric alcohol esters of alkylthiopropionic acid. Dialkyl thiodipropionates having an alkyl group of 6 to 20 carbon atoms are preferably used in the present invention. Polyhydric alcohol esters of alkylthiopropionic acid preferably have an alkyl group of 4 to 20 carbon atoms. In this case, examples of the polyhydric alcohol used to form the polyhydric alcohol esters include glycerol, trimethylolethane, trimethylolpropane, pentaerythritol, and trishydroxyethyl isocyanurate. Examples of such dialkyl thiodipropionates include dilauryl thiodipropionate, dimyristyl thiodipropionate, and distearyl thiodipropionate. Examples of polyhydric alcohol esters of alkylthiopropionic acid include glycerol tributylthiopropionate, glycerol trioctylthiopropionate, glycerol trilaurylthiopropionate, glycerol tristearylthiopropionate, trimethylolethane tributylthiopropionate, trimethylolethane trioctylthiopropionate, trimethylolethane trilaurylthiopropionate, trimethylolethane tristearylthiopropionate, pentaerythritol tetrabutylthiopropionate, pentaerythritol tetraoctylthiopropionate, pentaerythritol tetralaurylthiopropionate, and pentaerythritol tetrastearylthiopropionate.

Examples of the amine antioxidant include bis(2,2,6,6-tetramethyl-4-piperidyl)sebacate, polycondensates of dimethyl succinate and 1-(2-hydroxyethyl)-4-hydroxy-2,2,6,6-tetramethylpiperidineethanol, N,N′,N″,N″′-tetrakis(4,6-bis(butyl-(N-methyl-2,2,6,6-tetramethylpiperidine-4-yl)amino)-triazine-2-yl)-4,7-diazadecane-1,10-diamine, polycondensates of dibutylamine-1,3,5-triazine-N,N′-bis(2,2,6,6-tetramethyl-4-piperidyl)-1,6-hexamethylenediamine and N-(2,2,6,6-tetramethyl-4-piperidyl)butylamine, poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], tetrakis(2,2,6,6-tetramethyl-4-piperidyl)-1,2,3,4-butanetetracarboxylate, 2,2,6,6-tetramethyl-4-piperidyl benzoate, bis(1,2,6,6-pentamethyl-4-piperidyl)-2-(3,5-di-tert-butyl-4-hydroxybenzyl)-2-n-butyl malonate, bis(N-methyl-2,2,6,6-tetramethyl-4-piperidyl)sebacate, 1,1′-(1,2-ethanediyl)-bis(3,3,5,5-tetramethylpiperadinone), (mixed 2,2,6,6-tetramethyl-4-piperidyl/tridecyl)-1,2,3,4-butanetetracarboxylate, (mixed 1,2,2,6,6-pentamethyl-4-piperidyl/tridecyl)-1,2,3,4-butanetetracarboxylate, mixed [2,2,6,6-tetramethyl-4-piperidyl/β,β,β′,β′-tetramethyl-3,9-[2,4,8,10-tetraoxaspiro(5,5)undecane]diethyl]-1,2,3,4-butanetetracarboxylate, mixed [1,2,2,6,6-pentamethyl-4-piperidyl/β,β,β′,β′-tetramethyl-3,9-[2,4,8,10-tetraoxaspiro(5,5)undecane]diethyl]-1,2,3,4-butanetetracarboxylate, condensates of N,N′-bis(3-aminopropyl)ethylenediamine-2,4-bis[N-butyl-N-(1,2,2,6,6-pentamethyl-4-piperidyl)amino]-6-chloro-1,3,5-triazine, poly[6-N-morpholyl-1,3,5-triazine-2,4-diyl][(2,2,6,6-tetramethyl-4-piperidyl)imino]hexamethylene[(2,2,6,6-tetramethyl-4-piperidyl)imide], condensates of N,N′-bis(2,2,6,6-tetramethyl-4-piperidyl)hexamethylenediamine and 1,2-dibromoethane, and [N-(2,2,6,6-tetramethyl-4-piperidyl)-2-methyl-2-(2,2,6,6-tetramethyl-4-piperidyl)imino]propionamide.

To prevent the end of the polarizing film from having a defective appearance, the pressure-sensitive adhesive composition preferably contains 0.005 to 2 parts by weight, more preferably 0.1 to 1 part by weight of the antioxidant based on 100 parts by weight of the (meth)acryl-based polymer.

In the present invention, the pressure-sensitive adhesive composition used to form the pressure-sensitive adhesive layer may further contain a crosslinking agent. The crosslinking agent may be an organic crosslinking agent or a polyfunctional metal chelate. Examples of the organic crosslinking agent include an isocyanate crosslinking agent, a peroxide crosslinking agent, an epoxy crosslinking agent, an imine crosslinking agent, etc. The polyfunctional metal chelate is a compound containing a polyvalent metal covalently or coordinately bonded to an organic compound. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include an alkyl ester, an alcohol compound, a carboxylic acid compound, an ether compound, and a ketone compound.

The crosslinking agent is preferably an isocyanate crosslinking agent and/or a peroxide. Examples of compounds for use as isocyanate crosslinking agents include isocyanate monomers such as tolylene diisocyanate, chlorophenylene diisocyanate, tetramethylene diisocyanate, xylylene diisocyanate, diphenylmethane diisocyanate, and hydrogenated diphenylmethane diisocyanate, and isocyanate, isocyanurate, or biuret compounds produced by adding any of these isocyanate monomers to trimethylolpropane or other compounds; and urethane prepolymer type isocyanates produced by addition reaction of any of these isocyanate compounds with polyether polyols, polyester polyols, acrylic polyols, polybutadiene polyols, polyisoprene polyols, or other polyols. Particularly preferred is a polyisocyanate compound such as one selected from the group consisting of hexamethylene diisocyanate, hydrogenated xylylene diisocyanate, and isophorone diisocyanate, or a derivative thereof. Examples of one selected from the group consisting of hexamethylene diisocyanate, hydrogenated xylylene diisocyanate, and isophorone diisocyanate, or a derivative thereof include hexamethylene diisocyanate, hydrogenated xylylene diisocyanate, isophorone diisocyanate, polyol-modified hexamethylene diisocyanate, polyol-modified hydrogenated xylylene diisocyanate, trimer-type hydrogenated xylylene diisocyanate, and polyol-modified isophorone diisocyanate. The listed polyisocyanate compounds are preferred because their reaction with a hydroxyl group quickly proceeds as if an acid or a base contained in the polymer acts as a catalyst, which particularly contributes to the rapidness of the crosslinking.

Any peroxide capable of generating active radical species upon heating or exposure to light and capable of crosslinking the base polymer in the pressure-sensitive adhesive composition can be used appropriately. In view of workability or stability, a peroxide with a one-minute half-life temperature of 80° C. to 160° C. is preferably used, and a peroxide with a one-minute half-life temperature of 90° C. to 140° C. is more preferably used.

Examples of peroxides that may be used in the present invention include di(2-ethylhexyl)peroxydicarbonate (one-minute half-life temperature: 90.6° C.), di(4-tert-butylcyclohexyl)peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoyl peroxide (one-minute half-life temperature: 117.4° C.), 1,1,3,3-tetramethylbutylperoxy-2-ethyl hexanoate (one-minute half-life temperature: 124.3° C.), di(4-methylbenzoyl)peroxide (one-minute half-life temperature: 128.2° C.), dibenzoyl peroxide (one-minute half-life temperature: 130.0° C.), tert-butyl peroxyisobutyrate (one-minute half-life temperature: 136.1° C.), and 1,1-di(tert-hexylperoxy)cyclohexane (one-minute half-life temperature: 149.2° C.). In particular, di(4-tert-butylcyclohexyl)peroxydicarbonate (one-minute half-life temperature: 92.1° C.), dilauroyl peroxide (one-minute half-life temperature: 116.4° C.), and dibenzoyl peroxide (one-minute half-life temperature: 130.0° C.) are preferably used because they can provide higher crosslinking reaction efficiency.

The half-life of a peroxide, which is an indicator of how fast the peroxide can be decomposed, refers to the time required for the remaining amount of the peroxide to reach one half of the original amount. The decomposition temperature required for a certain half life time and the half life time obtained at a certain temperature are shown in catalogs furnished by manufacturers, such as Organic Peroxide Catalog, 9th Edition, May, 2003 furnished by NOF CORPORATION.

In the present invention, the use of the peroxide crosslinking agent alone or the use of the peroxide crosslinking agent in combination with the isocyanate crosslinking agent is particularly preferred. According to this feature, the use of the peroxide makes it possible to efficiently form three-dimensionally crosslinked networks in the pressure-sensitive adhesive layer while oxygen-induced inhibition of radical crosslinking is effectively suppressed by the antioxidant. As a result, the end of the polarizing film can be more effectively prevented from having a defective appearance.

The amount of the crosslinking agent in the pressure-sensitive adhesive composition is preferably from 0.01 to 20 parts by weight, more preferably from 0.03 to 10 parts by weight, based on 100 parts by weight of the (meth)acryl-based polymer. If the amount of the crosslinking agent is less than 0.01 parts by weight, the pressure-sensitive adhesive may tend to have insufficient cohesive strength, and foaming may occur during the heating of the composition. On the other hand, if it is more than 20 parts by weight, the pressure-sensitive adhesive may have insufficient moisture resistance and may easily peel off in a reliability test or the like.

For example, the amount of decomposition of the peroxide can be determined by a method of measuring the peroxide residue after the reaction process by high performance liquid chromatography (HPLC).

More specifically, for example, after the reaction process, about 0.2 g of each pressure-sensitive adhesive composition is taken out and immersed in 10 ml of ethyl acetate and subjected to shaking extraction at 25° C. and 120 rpm for 3 hours in a shaker, and then allowed to stand at room temperature for 3 days. Subsequently, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

In the present invention, the pressure-sensitive adhesive composition may further contain a silane coupling agent. Durability can be improved using a silane coupling agent. Examples of such a silane coupling agent include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-2-(aminoethyl)-3-aminopropylmethyldimethoxysilane, 3-triethoxysilyl-N-(1,3-dimethylbutylidene)propylamine, and N-phenyl-γ-aminopropyltrimethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatopropyltriethoxysilane.

One or more of the silane coupling agents may be used alone or in any combination. The total amount of the silane coupling agent(s) is preferably from 0.001 to 5 parts by weight, more preferably from 0.01 to 1 part by weight, even more preferably from 0.02 to 1 part by weight, further more preferably from 0.05 to 0.6 parts by weight, based on 100 parts by weight of the (meth)acryl-based polymer. Using such an amount of the silane coupling agent, durability can be improved, and the adhering strength to an optical member such as a liquid crystal cell can be kept at an appropriate level.

In the present invention, a polyether-modified silicone may also be added to the pressure-sensitive adhesive composition for use in forming the pressure-sensitive adhesive layer. For example, the polyether-modified silicone disclosed in JP-A-2010-275522 may be used.

The polyether-modified silicone may have a polyether skeleton and a reactive silyl group at least one end, wherein the reactive silyl group is represented by general formula (3): —SiRₐM₃₋ₐ, wherein R is a monovalent organic group having 1 to 20 carbon atoms and optionally having a substituent, M is a hydroxyl group or a hydrolyzable group, and a is an integer of 0 to 2. In the formula, two or more R groups, if any, may be the same or different, and two or more M groups, if any, may be the same or different.

The polyether-modified silicone may be a compound represented by general formula (4): RₐM₃₋ₐSi—X—Y-(AO)ₙ—Z. In formula (4), R is a monovalent organic group having 1 to 20 carbon atoms and optionally having a substituent, M is a hydroxyl group or a hydrolyzable group, and a is an integer of 0 to 2. In the formula, two or more R groups, if any, may be the same or different, and two or more M groups, if any, may be the same or different. AO is a straight- or branched-chain oxyalkylene group of 1 to 10 carbon atoms, and n is the average number of moles of the added oxyalkylene group and is from 1 to 1,700. X is a straight- or branched-chain alkylene group of 1 to 20 carbon atoms. Y is an ether bond, an ester bond, a urethane bond, or a carbonate bond.

Z is a hydrogen atom, a monovalent hydrocarbon group of 1 to 10 carbon atoms, a group represented by general formula (4A): —Y₁—X—SiRₐM₃₋ₐ, wherein R, M, X, and a have the same meanings as defined above, and Y¹ is a single bond, a —CO— bond, a —CONH— bond, or a —COO— bond, or a group represented by general formula (4B): -Q{-(OA)ₙ-Y—X—SiRₐM₃₋ₐ}ₘ, wherein R, M, X, Y, and a have the same meanings as defined above, OA has the same meaning as AO defined above, n has the same meaning as defined above, Q is a divalent or polyvalent hydrocarbon group of 1 to 10 carbon atoms, and m is a number that is the same as the valence of the hydrocarbon group.

Specific examples of the polyether-modified silicone include MS Polymers S203, S303 and S810 manufactured by Kaneka Corporation; SILYL EST250 and EST280 manufactured by Kaneka Corporation; SILYL SAT10, SILYL SAT200, SILYL SAT220, SILYL SAT350, and SILYL SAT400 manufactured by Kaneka Corporation; and EXCESTAR S2410, S2420, or S3430 manufacture by ASAHI GLASS CO., Ltd.

In the present invention, the pressure-sensitive adhesive composition for use in forming the pressure-sensitive adhesive layer may also contain any other known additive such as a powder of a colorant, a pigment, or the like, a dye, a surfactant, a plasticizer, a tackifier, a surface lubricant, a leveling agent, a softening agent, an age resistor, a light stabilizer, an ultraviolet absorber, a polymerization inhibitor, an inorganic or organic filler, a metal powder, or a particulate or flaky material, which may be added as appropriate depending on the intended use. Within the controllable range, a reducing agent may also be added to form a redox system.

In the present invention, when the pressure-sensitive adhesive layer is formed, it is preferred that the total content of the crosslinking agent should be controlled and that the effect of the crosslinking temperature or the crosslinking time should be carefully taken into account.

The crosslinking temperature and the crosslinking time may be controlled depending on the type of the crosslinking agent to be used. The crosslinking temperature is preferably 170° C. or lower.

The crosslinking process may be performed at the temperature where the process of drying the pressure-sensitive adhesive layer is performed, or an independent crosslinking process may be performed after the drying process.

The crosslinking time may be determined in view of productivity or workability. The crosslinking time is generally from about 0.2 to 20 minutes, preferably from about 0.5 to 10 minutes.

For example, the pressure-sensitive adhesive layer can be formed by a method including applying the pressure-sensitive adhesive composition to a release-treated separator or the like, removing the polymerization solvent and so on from the composition by drying to form a pressure-sensitive adhesive layer, and then transferring the pressure-sensitive adhesive layer onto a polarizing film. Alternatively, the pressure-sensitive adhesive layer can be formed by a method including applying the pressure-sensitive adhesive composition to a polarizing film, removing the polymerization solvent and so on from the composition to form a pressure-sensitive adhesive layer on the polarizing film. In the process of applying the pressure-sensitive adhesive, if necessary, one or more solvents other than the polymerization solvent may be newly added to the composition.

A silicone release liner is preferably used as the release-treated separator. The adhesive composition according to the present invention may be applied to such a liner and dried to form a pressure-sensitive adhesive layer. In this process, any appropriate method may be used for drying the pressure-sensitive adhesive, depending on the purpose. Preferably, a method of heating and drying the coating is used. The heating and drying temperature is preferably from 40° C. to 200° C., more preferably from 50° C. to 180° C., even more preferably from 70° C. to 170° C. When the heating temperature falls within the range, a pressure-sensitive adhesive with a high level of adhesive properties can be obtained.

The drying may be performed for any appropriate time. The drying time is preferably from 5 seconds to 20 minutes, more preferably from 5 seconds to 10 minutes, even more preferably from 10 seconds to 5 minutes.

The surface of the polarizing film may also be coated with an anchor layer or subjected to any of various adhesion-facilitating treatments such as a corona treatment and a plasma treatment, before the pressure-sensitive adhesive layer is formed. The surface of the pressure-sensitive adhesive layer may also be subjected to an adhesion-facilitating treatment.

Various methods may be used to form the pressure-sensitive adhesive layer. Examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The thickness of the pressure-sensitive adhesive layer is typically, but not limited to, about 3 to about 35 μm. It is preferably 5 to 30 μm, more preferably 8 to 25 μm.

When the surface of the pressure-sensitive adhesive layer is exposed, the pressure-sensitive adhesive layer may be protected by a release-treated sheet (separator) until it is actually used.

Examples of the material used to form such a separator include a plastic film such as a polyethylene, polypropylene, polyethylene terephthalate, or polyester film, a porous material such as paper, cloth, or nonwoven fabric, and appropriate thin materials such as a net, a foamed sheet, a metal foil, and a laminate thereof. A plastic film is advantageously used because of its good surface smoothness.

Such a plastic film may be of any type capable of protecting the pressure-sensitive adhesive layer. For example, such a plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The separator generally has a thickness of about 5 to about 200 μm, preferably about 5 to about 100 μm. If necessary, the separator may be subjected to a release treatment and an anti-pollution treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the separator is appropriately subjected to a release treatment such as a silicone treatment, a long-chain alkyl treatment, or a fluorine treatment, the peeling properties from the pressure-sensitive adhesive layer can be further improved.

The release-treated sheet used in the preparation of the pressure-sensitive adhesive layer-attached polarizing film may be used by itself as a separator for the pressure-sensitive adhesive layer-attached polarizing film, so that the process can be simplified.

The pressure-sensitive adhesive layer-attached polarizing film according to the present invention includes at least a polarizing film and a pressure-sensitive adhesive layer made from the pressure-sensitive adhesive composition described above. The polarizing film generally includes a polarizer and a transparent protective film or films provided on one or both sides of the polarizer.

To meet the need for the reduction in the thickness of the pressure-sensitive adhesive layer-attached polarizing film, the polarizing film has a total thickness of 100 μm or less. Any of various types of polarizers may be used without limitation to form the polarizing film. To reduce the thickness, a thin polarizer with a thickness of 10 μm or less is preferably used. To make the product thinner, the thickness of the polarizer is more preferably from 1 to 7 μm. Such a thin polarizer is less uneven in thickness, has good visibility, and is less dimensionally-variable and thus has high durability. It is also preferred because it can form a thinner polarizing film.

Typical examples of such a thin polarizer include the thin polarizing films (polarizers) described in JP-A-51-069644, JP-A-2000-338329, WO2010/100917, PCT/JP2010/001460, Japanese Patent Application No. 2010-269002, and Japanese Patent Application No. 2010-263692. These thin polarizing films can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage, which would otherwise be caused by stretching of the layer supported on a stretchable resin substrate.

Among processes including the steps of stretching and dyeing a laminate, a process capable of achieving high-ratio stretching to improve polarizing performance is preferably used when the thin polarizing film is formed. Thus, the thin polarizing film is preferably obtained by a process including the step of stretching in an aqueous boric acid solution as described in WO2010/100917, PCT/JP2010/001460, Japanese Patent Application No. 2010-269002, or Japanese Patent Application No. 2010-263692, and more preferably obtained by a process including the step of performing auxiliary in-air stretching before stretching in an aqueous boric acid solution as described in Japanese Patent Application No. 2010-269002 or 2010-263692.

PCT/JP2010/001460 describes a thin highly-functional polarizing film that is formed integrally with a resin substrate, made of a PVA-based resin containing an oriented dichroic material, and has a thickness of 7 μm or less and the optical properties of a single transmittance of 42.0% or more and a degree of polarization of 99.95% or more.

This thin highly-functional polarizing film can be produced by a process including forming a PVA-based resin coating on a resin substrate with a thickness of at least 20 μm, drying the coating to form a PVA-based resin layer, immersing the resulting PVA-based resin layer in a dyeing liquid containing a dichroic material to adsorb the dichroic material to the PVA-based resin layer, and stretching the PVA-based resin layer, which contains the adsorbed dichroic material, together with the resin substrate in an aqueous boric acid solution to a total stretch ratio of 5 times or more the original length.

A laminated film including a thin highly-functional polarizing film containing an oriented dichroic material can also be produced by a method including the steps of: applying a PVA-based resin-containing aqueous solution to one side of a resin substrate with a thickness of at least 20 μm, drying the coating to form a PVA-based resin layer so that a laminated film including the resin substrate and the PVA-based resin layer formed thereon is produced; immersing the laminated film in a dyeing liquid containing a dichroic material to adsorb the dichroic material to the PVA-based resin layer in the laminated film, wherein the laminated film includes the resin substrate and the PVA-based resin layer formed on one side of the resin substrate; and stretching the laminated film, which has the PVA-based resin layer containing the adsorbed dichroic material, in an aqueous boric acid solution to a total stretch ratio of 5 times or more the original length, wherein the PVA-based resin layer containing the adsorbed dichroic material is stretched together with the resin substrate, so that a laminated film including the resin substrate and a thin highly-functional polarizing film formed on one side of the resin substrate is produced, in which the thin highly-functional polarizing film is made of the PVA-based resin layer containing the oriented dichroic material and has a thickness of 7 μm or less and the optical properties of a single transmittance of 42.0% or more and a degree of polarization of 99.95% or more.

In the present invention, the polarizer with a thickness of 10 μm or less used to form the pressure-sensitive adhesive layer-attached polarizing film may be a polarizing film in the form of a continuous web including a PVA-based resin containing an oriented dichroic material. Such a polarizing film can be obtained by a two-stage stretching process including auxiliary in-air stretching of a laminate including a thermoplastic resin substrate and a polyvinyl alcohol-based resin layer formed thereon and stretching of the laminate in an aqueous boric acid solution. The thermoplastic resin substrate is preferably an amorphous polyester-based thermoplastic resin substrate or a crystalline polyester-based thermoplastic resin substrate.

The thin polarizing film disclosed in Japanese Patent Application No. 2010-269002 or 2010-263692 is a polarizing film in the form of a continuous web including a PVA-based resin containing an oriented dichroic material, which is made with a thickness of 10 μm or less by a two-stage stretching process including auxiliary in-air stretching of a laminate and stretching of the laminate in an aqueous boric acid solution, wherein the laminate includes an amorphous polyester-based thermoplastic resin substrate and a PVA-based resin layer formed thereon. This thin polarizing film is preferably made to have optical properties satisfying the following conditions: P>−(10^{0.929T-42.4}−1)×100 (provided that T<42.3) and P≧99.9 (provided that T≧42.3), wherein T represents the single transmittance, and P represents the degree of polarization.

Specifically, the thin polarizing film can be produced by a thin polarizing film-manufacturing method including the steps of: performing elevated temperature in-air stretching of a PVA-based resin layer formed on an amorphous polyester-based thermoplastic resin substrate in the form of a continuous web, so that a stretched intermediate product including an oriented PVA-based resin layer is produced; adsorbing a dichroic material (which is preferably iodine or a mixture of iodine and an organic dye) to the stretched intermediate product to produce a dyed intermediate product including the PVA-based resin layer and the dichroic material oriented therein; and performing stretching of the dyed intermediate product in an aqueous boric acid solution so that a polarizing film with a thickness of 10 μm or less is produced, which includes the PVA-based resin layer and the dichroic material oriented therein.

In this manufacturing method, the elevated temperature in-air stretching and the stretching in an aqueous boric acid solution are preferably performed in such a manner that the PVA-based resin layer formed on the amorphous polyester-based thermoplastic resin substrate is stretched to a total stretch ratio of 5 times or more. The aqueous boric acid solution preferably has a temperature of 60° C. or more for the stretching therein. Before stretched in the aqueous boric acid solution, the dyed intermediate product is preferably subjected to an insolubilization treatment, in which the dyed intermediate product is preferably immersed in an aqueous boric acid solution at a temperature of 40° C. or less. The amorphous polyester-based thermoplastic resin substrate may be made of amorphous polyethylene terephthalate including co-polyethylene terephthalate in which isophthalic acid, cyclohexanedimethanol, or any other monomer is copolymerized. The amorphous polyester-based thermoplastic resin substrate is preferably made of a transparent resin. The thickness of the substrate may be at least seven times the thickness of the PVA-based resin layer to be formed. The elevated temperature in-air stretching is preferably performed at a stretch ratio of 3.5 times or less. The temperature of the elevated temperature in-air stretching is preferably equal to or higher than the glass transition temperature of the PVA-based resin. Specifically, it is preferably in the range of 95° C. to 150° C. When the elevated temperature in-air stretching is end-free uniaxial stretching, the PVA-based resin layer formed on the amorphous polyester-based thermoplastic resin substrate is preferably stretched to a total stretch ratio of 5 to 7.5 times. When the elevated temperature in-air stretching is fixed-end uniaxial stretching, the PVA-based resin layer formed on the amorphous polyester-based thermoplastic resin substrate is preferably stretched to a total stretch ratio of 5 to 8.5 times.

More specifically, the thin polarizing film can be produced by the method described below.

A substrate is prepared in the form of a continuous web, which is made of co-polyethylene terephthalate-isophthalate (amorphous PET) containing 6 mol % of copolymerized isophthalic acid. The amorphous PET has a glass transition temperature of 75° C. A laminate of a polyvinyl alcohol (PVA) layer and the amorphous PET substrate in the form of a continuous web is prepared as described below. For reference, the glass transition temperature of PVA is 80° C.

A 200-μm-thick amorphous PET substrate is provided, and an aqueous 4-5% PVA solution is prepared by dissolving PVA powder with a polymerization degree of 1,000 or more and a saponification degree of 99% or more in water. Subsequently, the aqueous PVA solution is applied to the 200-μm-thick amorphous PET substrate and dried at a temperature of 50 to 60° C. so that a laminate composed of the amorphous PET substrate and a 7-μm-thick PVA layer formed thereon is obtained.

The laminate having the 7-μm-thick PVA layer is subjected to a two-stage stretching process including auxiliary in-air stretching and stretching in an aqueous boric acid solution as described below, so that a thin highly-functional polarizing film with a thickness of 3 μm is obtained. At the first stage, the laminate having the 7-μm-thick PVA layer is subjected to an auxiliary in-air stretching step so that the layer is stretched together with the amorphous PET substrate to form a stretched laminate having a 5-μm-thick PVA layer. Specifically, the stretched laminate is formed by a process including feeding the laminate having the 7-μm-thick PVA layer to a stretching apparatus placed in an oven with the stretching temperature environment set at 130° C. and subjecting the laminate to end-free uniaxial stretching to a stretch ratio of 1.8 times. In the stretched laminate, the PVA layer is modified, by the stretching, into a 5-μm-thick PVA layer containing oriented PVA molecules.

Subsequently, a dyeing step is performed to produce a dyed laminate having a 5-μm-thick PVA layer containing oriented PVA molecules and adsorbed iodine. Specifically, the dyed laminate is produced by immersing the stretched laminate for a certain period of time in a dyeing liquid containing iodine and potassium iodide and having a temperature of 30° C. so that iodine can be adsorbed to the PVA layer of the stretched laminate and so that the PVA layer for finally forming a highly-functional polarizing film can have a single transmittance of 40 to 44%. In this step, the dyeing liquid contains water as a solvent and has an iodine concentration in the range of 0.12 to 0.30% by weight and a potassium iodide concentration in the range of 0.7 to 2.1% by weight. The concentration ratio of iodine to potassium iodide is 1:7. It should be noted that potassium iodide is necessary to make iodine soluble in water. More specifically, the stretched laminate is immersed for 60 seconds in a dyeing liquid containing 0.30% by weight of iodine and 2.1% by weight of potassium iodide, so that a dyed laminate is produced, in which the 5-μm-thick PVA layer contains oriented PVA molecules and adsorbed iodine.

At the second stage, the dyed laminate is further subjected to a stretching step in an aqueous boric acid solution so that the layer is further stretched together with the amorphous PET substrate to form an optical film laminate having a 3-μm-thick PVA layer, which forms a highly-functional polarizing film. Specifically, the optical film laminate is formed by a process including feeding the dyed laminate to a stretching apparatus placed in a treatment system in which an aqueous boric acid solution containing boric acid and potassium iodide is set in the temperature range of 60 to 85° C. and subjecting the laminate to end-free uniaxial stretching to a stretch ratio of 3.3 times. More specifically, the aqueous boric acid solution has a temperature of 65° C. In the solution, the boric acid content and the potassium iodide content are 4 parts by weight and 5 parts by weight, respectively, based on 100 parts by weight of water. In this step, the dyed laminate having a controlled amount of adsorbed iodine is first immersed in the aqueous boric acid solution for 5 to 10 seconds. Subsequently, the dyed laminate is directly fed between a plurality of pairs of rolls different in peripheral speed, which form the stretching apparatus placed in the treatment system, and subjected to end-free uniaxial stretching for 30 to 90 seconds to a stretch ratio of 3.3 times. This stretching treatment converts the PVA layer of the dyed laminate to a 3-μm-thick PVA layer in which the adsorbed iodine forms a polyiodide ion complex highly oriented in a single direction. This PVA layer forms a highly-functional polarizing film in the optical film laminate.

A cleaning step, although not essential for the manufacture of the optical film laminate, is preferably performed, in which the optical film laminate is taken out of the aqueous boric acid solution, and boric acid deposited on the surface of the 3-μm-thick PVA layer formed on the amorphous PET substrate is washed off with an aqueous potassium iodide solution. Subsequently, the cleaned optical film laminate is dried in a drying step using warm air at 60° C. It should be noted that the cleaning step is to prevent appearance defects such as boric acid precipitation.

A lamination and/or transfer step, although not essential for the manufacture of the optical film laminate, may also be performed, in which an 80-μm-thick triacetylcellulose film is bonded to the surface of the 3-μm-thick PVA layer on the amorphous PET substrate, while an adhesive is applied to the surface, and then the amorphous PET substrate is peeled off, so that the 3-μm-thick PVA layer is transferred onto the 80-μm-thick triacetylcellulose film.

### [Other Steps]

The thin polarizing film-manufacturing method may include other steps in addition to the above steps. For example, such other steps may include an insolubilization step, a crosslinking step, a drying step (moisture control), etc. Other steps may be performed at any appropriate timing.

The insolubilization step is typically achieved by immersing the PVA-based resin layer in an aqueous boric acid solution. The insolubilization treatment can impart water resistance to the PVA-based resin layer. The concentration of boric acid in the aqueous boric acid solution is preferably from 1 to 4 parts by weight based on 100 parts by weight of water. The insolubilization bath (aqueous boric acid solution) preferably has a temperature of 20° C. to 50° C. Preferably, the insolubilization step is performed after the preparation of the laminate and before the dyeing step or the step of stretching in water.

The crosslinking step is typically achieved by immersing the PVA-based resin layer in an aqueous boric acid solution. The crosslinking treatment can impart water resistance to the PVA-based resin layer. The concentration of boric acid in the aqueous boric acid solution is preferably from 1 to 4 parts by weight based on 100 parts by weight of water. When the crosslinking step is performed after the dyeing step, an iodide is preferably added to the solution. The addition of an iodide can suppress the elution of adsorbed iodine from the PVA-based resin layer. The amount of the addition of an iodide is preferably from 1 to 5 parts by weight based on 100 parts by weight of water. Examples of the iodide include those listed above. The temperature of the crosslinking bath (aqueous boric acid solution) is preferably from 20° C. to 50° C. Preferably, the crosslinking step is performed before the second stretching step in the aqueous boric acid solution. In a preferred embodiment, the dyeing step, the crosslinking step, and the second stretching step in the aqueous boric acid solution are performed in this order.

The material used to form the transparent protective film is typically thermoplastic resin with a high level of transparency, mechanical strength, thermal stability, water blocking properties, isotropy, etc. Examples of such thermoplastic resin include cellulose resin such as triacetylcellulose, polyester resin, polyethersulfone resin, polysulfone resin, polycarbonate resin, polyamide resin, polyimide resin, polyolefin resin, (meth)acrylic resin, cyclic polyolefin resin (norbornene resin), polyarylate resin, polystyrene resin, polyvinyl alcohol resin, and any blend thereof. The transparent protective film may be bonded to one side of the polarizer with an adhesive layer. In this case, thermosetting or ultraviolet-ray curing-type resin such as (meth)acrylic, urethane, acrylic urethane, epoxy, or silicone resin may be used to form a transparent protective film on the other side. The transparent protective film may contain any one or more appropriate additives. Examples of such an additive include an ultraviolet absorber, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, even more preferably from 60 to 98% by weight, further more preferably from 70 to 97% by weight. If the content of the thermoplastic resin in the transparent protective film is less than 50% by weight, high transparency and other properties inherent in the thermoplastic resin may be insufficiently exhibited.

The thickness of the transparent protective film is not restricted as long as the polarizing film has a total thickness of 100 μm or less. For example, the transparent protective film has a thickness of about 10 to about 90 μm. Its thickness is preferably from 15 to 60 μm, more preferably from 20 to 50 μm.

The polarizer and the transparent protective film may be bonded together with an adhesive. Examples of such an adhesive include isocyanate adhesives, polyvinyl alcohol-based adhesives, gelatin-based adhesives, vinyl adhesives, latex adhesives, and aqueous polyester adhesives. The adhesive is generally used in the form of an aqueous adhesive solution, which generally has a solids content of 0.5 to 60% by weight. Besides the above, ultraviolet-curable adhesives, electron beam-curable adhesives, or the like may also be used to bond the polarizer and the transparent protective film together. Electron beam-curable adhesives for use on polarizing films have good tackiness to the various transparent protective films described above. The adhesive for use in the present invention may also contain a metal compound filler.

The polarizing film and any other optical film or films may be placed on one another to form a laminate. Examples of such other optical films include a reflector, a transflector, a retardation plate (including a wavelength plate such as a half or quarter wavelength plate), a viewing angle compensation film, a brightness enhancement film, and any other optical layer that can be used to form a liquid crystal display device or the like. One or more layers of any of these optical components may be used together with the polarizing film to form a laminate for practical use.

The optical film including a laminate of the polarizing film and the optical layer may be formed by a method of stacking them one by one in the process of manufacturing a liquid crystal display or the like. However, an optical film formed in advance by lamination is advantageous in that it can facilitate the process of manufacturing a liquid crystal display device or the like, because it has stable quality and good assembling workability. In the lamination, any appropriate bonding means such as a pressure-sensitive adhesive layer may be used. When the polarizing film and any other optical layer are bonded together, their optical axes may be each aligned at an appropriate angle, depending on the desired retardation properties or other desired properties.

The pressure-sensitive adhesive layer-attached polarizing film of the present invention is preferably used to form a variety of image display devices such as liquid crystal display devices. Liquid crystal display devices may be formed according to conventional techniques. Specifically, a liquid crystal display device may be typically formed using any conventional technique including properly assembling a display panel such as a liquid crystal cell, a pressure-sensitive adhesive layer-attached polarizing film, and optional components such as lighting system components, and incorporating a driving circuit, except that the pressure-sensitive adhesive layer-attached polarizing film used is according to the present invention. The liquid crystal cell to be used may also be of any type such as TN type, STN type, π type, VA type, or IPS type.

Any desired liquid crystal display device may be formed, such as a liquid crystal display device including a display panel such as a liquid crystal cell and the pressure-sensitive adhesive layer-attached optical film or films placed on one or both sides of the display panel, or a liquid crystal display device further including a backlight or a reflector in a lighting system. In such a case, the pressure-sensitive adhesive layer-attached polarizing film or films according to the present invention may be placed on one or both sides of a display panel such as a liquid crystal cell. When the optical films are provided on both sides, they may be the same or different. The process of forming a liquid crystal display device may also include placing an appropriate component such as a diffusion plate, an anti-glare layer, an anti-reflection film, a protective plate, a prism array, a lens array sheet, a light diffusion plate, or a backlight in one or more layers at an appropriate position or positions.

### EXAMPLES

Hereinafter, the present invention will be more specifically described with reference to examples, which however are not intended to limit the present invention. In each example, “parts” and “%” are all by weight.

### <Measurement of Weight Average Molecular Weight of (Meth)Acryl-Based Polymer>

The weight average molecular weight of the hydroxyl group-containing (meth)acryl-based polymer (A) was determined using gel permeation chromatography (GPC). Analyzer: HLC-8120GPC manufactured by TOSOH CORPORATION, columns: GM7000H_{XL}+GMH_{XL}+GMH_{XL} manufactured by TOSOH CORPORATION, column size: each 7.8 mmφ×30 cm, 90 cm in total, column temperature: 40° C., flow rate: 0.8 ml/minute, injection volume: 100 μl, eluent: tetrahydrofuran, detector: differential refractometer (RI), standard sample: polystyrene.

### <Preparation of Polarizing Film (1)>

A thin polarizer was prepared as follows. First, a laminate including an amorphous PET substrate and a 9-μm-thick PVA layer formed thereon was subjected to auxiliary in-air stretching at a stretching temperature of 130° C. to form a stretched laminate. Subsequently, the stretched laminate was subjected to dyeing to form a dyed laminate, and the dyed laminate was subjected to stretching in an aqueous boric acid solution at a stretching temperature of 65° C. to a total stretch ratio of 5.94 times, so that an optical film laminate was obtained which had a 4-μm-thick PVA layer stretched together with the amorphous PET substrate. Such two-stage stretching successfully formed an optical film laminate having a 4-μm-thick PVA layer formed on the amorphous PET substrate, in which the PVA layer contained highly oriented PVA molecules and formed a highly-functional polarizer in which iodine adsorbed by the dyeing formed a polyiodide ion complex oriented highly in a single direction. A 40-μm-thick saponified acrylic resin film (transparent protective film (1)) was further bonded to the surface of the polarizer of the optical film laminate, while a polyvinyl alcohol-based adhesive was applied to the surface. The amorphous PET substrate was then peeled off, so that a polarizing film having a thin polarizer was obtained. Hereinafter, this product is called thin polarizing film (1). Table 1 shows the type of the polarizer, the type of the transparent protective film, and the total thickness.

### <Preparation of Polarizing Film (2)>

A thin polarizer was prepared as follows. First, a laminate including an amorphous PET substrate and a 9-μm-thick PVA layer formed thereon was subjected to auxiliary in-air stretching at a stretching temperature of 130° C. to form a stretched laminate. Subsequently, the stretched laminate was subjected to dyeing to form a dyed laminate, and the dyed laminate was subjected to stretching in an aqueous boric acid solution at a stretching temperature of 65° C. to a total stretch ratio of 5.94 times, so that an optical film laminate was obtained which had a 4-μm-thick PVA layer stretched together with the amorphous PET substrate. Such two-stage stretching successfully formed an optical film laminate having a 4-μm-thick PVA layer formed on the amorphous PET substrate, in which the PVA layer contained highly oriented PVA molecules and formed a highly-functional polarizer in which iodine adsorbed by the dyeing formed a polyiodide ion complex oriented highly in a single direction. A 40-μm-thick saponified acrylic resin film (transparent protective film (1)) was further bonded to the surface of the polarizer of the optical film laminate, while a polyvinyl alcohol-based adhesive was applied to the surface. Subsequently, after the amorphous PET substrate was peeled off, a 40-μm-thick norbornene-based film (transparent protective film (2)) was bonded to the other surface of the polarizer with a polyvinyl alcohol-based adhesive, so that a polarizing film having a thin polarizer was obtained. Hereinafter, this product is called thin polarizing film (2). Table 1 shows the type of the polarizer, the type of the transparent protective film, and the total thickness.

### <Preparation of Polarizing Film (3)>

An 80-μm-thick polyvinyl alcohol film was stretched to 3 times between rolls different in velocity ratio, while it was dyed in a 0.3% iodine solution at 30° C. for 1 minute. The film was then stretched to a total stretch ratio of 6 times, while it was immersed in an aqueous solution containing 4% boric acid and 10% potassium iodide at 60° C. for 0.5 minutes. Subsequently, the film was cleaned by immersion in an aqueous solution containing 1.5% potassium iodide at 30° C. for 10 seconds, and then dried at 50° C. for 4 minutes to give a 20-μm-thick polarizer. A 40-μm-thick saponified acrylic resin film (transparent protective film (1)) was further bonded to the surface of the polarizer, while a polyvinyl alcohol-based adhesive was applied to the surface. The amorphous PET substrate was then peeled off, so that a polarizing film having the polarizer was obtained. Hereinafter, this product is called thin polarizing film (3). Table 1 shows the type of the polarizer, the type of the transparent protective film, and the total thickness.

### <Preparation of Polarizing Film (4)>

An 80-μm-thick polyvinyl alcohol film was stretched to 3 times between rolls different in velocity ratio, while it was dyed in a 0.3% iodine solution at 30° C. for 1 minute. The film was then stretched to a total stretch ratio of 6 times, while it was immersed in an aqueous solution containing 4% boric acid and 10% potassium iodide at 60° C. for 0.5 minutes. Subsequently, the film was cleaned by immersion in an aqueous solution containing 1.5% potassium iodide at 30° C. for 10 seconds, and then dried at 50° C. for 4 minutes to give a 20-μm-thick polarizer. A 40-μm-thick saponified acrylic resin film (transparent protective film (1)) was further bonded to the surface of the polarizer of the optical film laminate, while a polyvinyl alcohol-based adhesive was applied to the surface. Subsequently, after the amorphous PET substrate was peeled off, a 30-μm-thick norbornene-based film (transparent protective film (2)) was bonded to the other surface of the polarizer with a polyvinyl alcohol-based adhesive, so that a film was obtained. Hereinafter, this product is called thin polarizing film (4). Table 1 shows the type of the polarizer, the type of the transparent protective film, and the total thickness.

TABLE 1

| | | Transparent | Transparent | |
|---|---|---|---|---|
| | | protective | protective | Total |
| | Polarizer | film 1 | film 2 | thickness |
| | (μm) | (μm) | (μm) | (μm) |
| Thin polarizing | 4 | 40 | — | 44 |
| film (1) | | | | |
| Thin polarizing | 4 | 40 | 40 | 84 |
| film (2) | | | | |
| Thin polarizing | 20 | 40 | — | 60 |
| film (3) | | | | |
| Thin polarizing | 20 | 40 | 30 | 90 |
| film (4) | | | | |

### Production Example 1

### Preparation of (Meth)Acryl-Based Polymer (A-1)

To a reaction vessel equipped with a condenser tube, a nitrogen-introducing tube, a thermometer, and a stirrer were added 99 parts of butyl acrylate, 1 part of 4-hydroxybutyl acrylate (HBA), and 1 part of azobisisobutyronitrile (AIBN) (based on 100 parts of the solids of the monomers) as an initiator together with ethyl acetate. Under a nitrogen gas stream, the mixture was allowed to react at 60° C. for 7 hours. Ethyl acetate was then added to the reaction liquid, so that a solution containing a hydroxyl group-containing (meth)acryl-based polymer (A-1) with an average molecular weight of 1,600,000 was obtained (30% by weight in solid concentration). Table 2 shows the composition and molecular weight of the (meth)acryl-based polymer (A-1).

### Production Example 2

### Preparation of (Meth)Acryl-Based Polymer (A-2)

A solution of a (meth)acryl-based polymer (A-2) with a weight average molecular weight of 1,600,000 was prepared as in Production Example 1, except that a monomer mixture containing 99 parts of butyl acrylate and 1 part of 2-hydroxyethyl acrylate (HEA) was used instead. Table 2 shows the composition and molecular weight of the (meth)acryl-based polymer (A-2).

### Production Example 3

### Preparation of (Meth)Acryl-Based Polymer (A-3)

A solution of a (meth)acryl-based polymer (A-3) with a weight average molecular weight of 1,600,000 was prepared as in Production Example 1, except that a monomer mixture containing 98 parts of butyl acrylate, 1 part of 4-hydroxybutyl acrylate, and 1 part of acrylic acid was used instead. Table 2 shows the composition and molecular weight of the (meth)acryl-based polymer (A-3).

### Production Example 4

### Preparation of (Meth)Acryl-Based Polymer (A-4)

A solution of a (meth)acryl-based polymer (A-4) with a weight average molecular weight of 1,600,000 was prepared as in Production Example 1, except that 100 parts of butyl acrylate was used instead. Table 2 shows the composition and molecular weight of the (meth)acryl-based polymer (A-4).

### Production Example 5

### Preparation of (Meth)Acryl-Based Polymer (A-5)

A solution of a (meth)acryl-based polymer (A-5) with a weight average molecular weight of 1,150,000 was prepared using the process of Production Example 1 under appropriately changed conditions. Table 2 shows the composition and molecular weight of the (meth)acryl-based polymer (A-5).

TABLE 2

| | | 4- | 2- | | |
|---|---|---|---|---|---|
| | Butyl | hydroxybutyl | hydroxyethyl | Acrylic | Molecular |
| | acrylate | acrylate | acrylate | acid | weight |
| | (BA) | (HBA) | (HEA) | (AA) | (×10,000) |
| Production | 99 | 1 | 0 | 0 | 160 |
| Example | | | | | |
| 1 (A-1) | | | | | |
| Production | 99 | 0 | 1 | 0 | 160 |
| Example | | | | | |
| 2 (A-2) | | | | | |
| Production | 98 | 1 | 0 | 1 | 160 |
| Example | | | | | |
| 3 (A-3) | | | | | |
| Production | 100 | 0 | 0 | 0 | 160 |
| Example | | | | | |
| 4 (A-4) | | | | | |
| Production | 99 | 1 | 0 | 0 | 115 |
| Example | | | | | |
| 5 (A-5) | | | | | |

### Example 1

### Preparation of Optical Pressure-Sensitive Adhesive

A pressure-sensitive adhesive composition was obtained by mixing the (meth)acryl-based polymer (A-1) prepared in Production Example 1; a crosslinking agent (C) including 0.1 parts of trimethylolpropane xylylene diisocyanate (Takenate D110N manufactured by Mitsui Chemicals, Inc. (C-1)) and 0.3 parts of dibenzoyl peroxide (C-2); 0.075 parts of γ-glycidoxypropylmethoxysilane (KBM-403 manufactured by Shin-Etsu Chemical Co., Ltd. (D)); and 0.3 parts of pentaerythritol tetrakis[3-(3,5-di-tert-butyl-4-hydroxyphenyl)propionate (IRGANOX 1010 manufactured by BASF Japan Ltd. (B)) as a phenolic antioxidant, based on 100 parts by weight of the solids in the (meth)acryl-based polymer (A-1) solution.

### (Preparation of Pressure-Sensitive Adhesive Layer-Attached Optical Film)

The pressure-sensitive adhesive composition was uniformly applied to the surface of a silicone release agent-treated polyethylene terephthalate film (backing) with a fountain coater, and dried for 2 minutes in an air circulation-type thermostatic oven at 155° C., so that a 20-μm-thick pressure-sensitive adhesive layer was formed on the surface of the backing. Subsequently, the pressure-sensitive adhesive layer-attached separator film was bonded to the polarizing film to form a pressure-sensitive adhesive layer-attached polarizing film.

### Examples 2 to 13 and Comparative Examples 1 to 6

Pressure-sensitive adhesive layer-attached polarizing films were prepared as in Example 1, except that the amount of each component was changed as shown in Table 1 when each pressure-sensitive adhesive composition was prepared and that the type of the polarizing film was changed as shown in Table 1 when each pressure-sensitive adhesive layer-attached polarizing film was prepared.

The pressure-sensitive adhesive layer-attached polarizing films obtained in the examples and the comparative examples were evaluated as described below. Table 3 shows the evaluation results.

### <Measurement of Gel Fraction>

For gel fraction measurement, 0.2 g of the pressure-sensitive adhesive obtained in each of the examples and the comparative examples was sampled and wrapped in fluororesin (TEMISH NTF-1122 manufactured by NITTO DENKO CORPORATION), whose weight (Wa) was measured in advance, in such a way that the optical pressure-sensitive adhesive did not leak out. The wrapped sample was measured for weight (Wb) and placed in a sample vial. To the vial was added 40 cc of ethyl acetate. The sample was then allowed to stand for 1 hour or 7 days. The fluororesin-wrapped sample was then taken out, placed on an aluminum cup, and dried at 130° C. for 2 hours. The weight (Wc) of the fluororesin-wrapped sample was measured. The gel fraction of the sample was determined from the following formula (I):

Gel fraction (% by weight)={(W_{c}−Wₐ)/(W_{b}−Wₐ)}×100.

### [Evaluation of Durability]

### <Durability Test on Pressure-Sensitive Adhesive Layer-Attached Polarizing Films (Peeling and Foaming)>

The separator film was peeled off from the pressure-sensitive adhesive layer-attached polarizing film obtained in each of the examples and the comparative examples. The polarizing film was bonded to a non-alkali glass plate and autoclaved at 50° C. and 5 atm for 15 minutes. Subsequently, the resulting laminate was stored in a heating oven at 80° C. and in a thermo-hygrostat at 60° C. and 90% RH, respectively.

After 500 hours, it was visually observed whether peeling and foaming occurred in the polarizing film. The case where absolutely no peeling or foaming was observed was rated as ∘ (very good), the case where peeling or foaming occurred to an invisible extent as ∘ (good), the case where slight visible peeling or foaming occurred as Δ (fair), and the case where significant peeling or foaming occurred as x (poor).

### <Durability Test on Pressure-Sensitive Adhesive Layer-Attached Polarizing Films (Defective Appearance of the End of Polarizing Film)>

Whether or not the end of each polarizing film had a defective appearance was evaluated by the following method. Each polarizing film was placed in a heating oven at 80° C. and in a thermo-hygrostat at 60° C. and 90% RH, respectively. After 500 hours, whether a difference in brightness occurred at the periphery of each pressure-sensitive adhesive layer-attached polarizing film was visually observed with respect to the degree of light leakage of crossed Nicols. The case where any defective appearance based on a difference in brightness was not observed at the end was rated as ∘ (good), and the case where a defective appearance was observed at the end as x (poor).

TABLE 3

| | | | | | | | | | | | | | Evaluations | | | |
|---|---|---|---|---|---|---|---|---|---|---|---|---|---|---|---|---|
| | | | | | | | | | | | | | Durability | | | |
| | | | | | | | | | | | | | | | Humidifying | |
| | | | | | | | | | | | | | Heating | | (at 60° C. and | |
| | | Pressure-sensitive adhesive composition | | | | | | | | | | | (at 80° C.) | | 90% RH) | |
| | | (Meth)- | | | | | | | | | | Physical | | Defective | | Defective |
| | | acryl- | | | | Crosslinking | | | | | | proper- | | appear- | | apear- |
| | | based | | Anti- | | agent (C) | | | | Silane | | ties | | ance | | ance |
| | | polymer | | oxidant | | | | Isocyanate | | coupling | | Gel | | of | | of |
| | Polarizing | (A) | | (B) | | Peroxide | | compound | | agent (D) | | fraction | Peeling/ | polarizing | Peeling/ | polarizing |
| | film | Type | Parts | Type | Parts | Type | Parts | Type | Parts | Type | Parts | (%) | foaming | film end | foaming | film end |
| Example 1 | Structural | A-1 | 100 | B | 0.3 | C-2 | 0.3 | C-1 | 0.1 | D | 0.075 | 84 | ⊙ | ⊙ | ⊙ | ⊙ |
| | Example 1 | | | | | | | | | | | | | | | |
| Example 2 | Structural | A-1 | 100 | B | 1.5 | C-2 | 0.3 | C-1 | 0.1 | D | 0.075 | 84 | ⊙ | ⊙ | ◯ | ⊙ |
| | Example 1 | | | | | | | | | | | | | | | |
| Example 3 | Structural | A-1 | 100 | B | 0.005 | C-2 | 0.3 | C-1 | 0.1 | D | 0.075 | 83 | ⊙ | ◯ | ⊙ | ⊙ |
| | Example 1 | | | | | | | | | | | | | | | |
| Example 4 | Structural | A-1 | 100 | B | 3 | C-2 | 0.3 | C-1 | 0.1 | D | 0.075 | 84 | ◯ | ⊙ | ◯ | ⊙ |
| | Example 1 | | | | | | | | | | | | | | | |
| Example 5 | Structural | A-1 | 100 | B | 0.3 | C-2 | 0.3 | C-1 | 0.1 | D | 0.075 | 84 | ⊙ | ⊙ | ⊙ | ⊙ |
| | Example 2 | | | | | | | | | | | | | | | |
| Example 6 | Structural | A-1 | 100 | B | 0.3 | C-2 | 0.3 | C-1 | 0.1 | D | 0.075 | 84 | ⊙ | ⊙ | ⊙ | ⊙ |
| | Example 3 | | | | | | | | | | | | | | | |
| Example 7 | Structural | A-1 | 100 | B | 0.3 | C-2 | 0.3 | C-1 | 0.1 | D | 0.075 | 84 | ⊙ | ⊙ | ⊙ | ⊙ |
| | Example 4 | | | | | | | | | | | | | | | |
| Example 8 | Structural | A-1 | 100 | B | 0.3 | C-2 | 0 | C-1 | 0.1 | D | 0.075 | 80 | ◯ | ⊙ | ◯ | ⊙ |
| | Example 1 | | | | | | | | | | | | | | | |
| Example 9 | Structural | A-2 | 100 | B | 0.3 | C-2 | 0.3 | C-1 | 0.1 | D | 0.075 | 80 | ◯ | ⊙ | ◯ | ⊙ |
| | Example 1 | | | | | | | | | | | | | | | |
| Example 10 | Structural | A-3 | 100 | B | 0.3 | C-2 | 0.3 | C-1 | 0.1 | D | 0.075 | 87 | ⊙ | ⊙ | ⊙ | ⊙ |
| | Example 1 | | | | | | | | | | | | | | | |
| Example 11 | Structural | A-3 | 100 | B | 0.3 | C-2 | 0 | C-1 | 0.1 | D | 0.075 | 85 | ⊙ | ⊙ | ◯ | ⊙ |
| | Example 1 | | | | | | | | | | | | | | | |
| Example 12 | Structural | A-4 | 100 | B | 0.3 | C-2 | 0.3 | C-1 | 0.1 | D | 0.075 | 70 | ◯ | ◯ | ◯ | ⊙ |
| | Example 1 | | | | | | | | | | | | | | | |
| Example 13 | Structural | A-5 | 100 | B | 0.3 | C-2 | 0.3 | C-1 | 0.1 | D | 0.075 | 82 | ◯ | ⊙ | ⊙ | ⊙ |
| | Example 1 | | | | | | | | | | | | | | | |
| Comparative | Structural | A-1 | 100 | B | 0 | C-2 | 0.3 | C-1 | 0.1 | D | 0.075 | 82 | ⊙ | X | ⊙ | ◯ |
| Example 1 | Example 1 | | | | | | | | | | | | | | | |
| Comparative | Structural | A-1 | 100 | B | 0 | C-2 | 0 | C-1 | 0.1 | D | 0.075 | 80 | ◯ | X | ◯ | ◯ |
| Example 2 | Example 1 | | | | | | | | | | | | | | | |
| Comparative | Structural | A-2 | 100 | B | 0 | C-2 | 0.3 | C-1 | 0.1 | D | 0.075 | 80 | ◯ | X | ⊙ | ◯ |
| Example 3 | Example 1 | | | | | | | | | | | | | | | |
| Comparative | Structural | A-2 | 100 | B | 0 | C-2 | 0 | C-1 | 0.1 | D | 0.075 | 78 | Δ | X | ◯ | ◯ |
| Example 4 | Example 1 | | | | | | | | | | | | | | | |
| Comparative | Structural | A-4 | 100 | B | 0 | C-2 | 0.3 | C-1 | 0.1 | D | 0.075 | 65 | Δ | X | Δ | ◯ |
| Example 5 | Example 1 | | | | | | | | | | | | | | | |
| Comparative | Structural | A-4 | 100 | B | 0 | C-2 | 0 | C-1 | 0.1 | D | 0.075 | 60 | X | X | X | ◯ |
| Example 6 | Example 1 | | | | | | | | | | | | | | | |

No defective appearance was observed at the end of the pressure-sensitive adhesive layer-attached polarizing films of the examples even after they were placed in a high-temperature atmosphere at 80° C. for 500 hours and in a high-temperature, high-humidity atmosphere at 60° C. and 90% RH for 500 hours, respectively. In contrast, a defective appearance was observed at the end of the polarizing films of the comparative examples where no antioxidant was contained in the pressure-sensitive adhesive composition used to form the pressure-sensitive adhesive layer.

What is claimed is:

1. A pressure-sensitive adhesive layer-attached polarizing film, comprising:
a polarizing film comprising a polarizer and a transparent protective film provided on at least one side of the polarizer, the polarizing film having a total thickness of 100 μm or less; and
a pressure-sensitive adhesive layer provided on the polarizing film and made a pressure-sensitive adhesive composition containing a (meth)acryl-based polymer and an antioxidant.

2. The pressure-sensitive adhesive layer-attached polarizing film according to claim 1, wherein the polarizer has a thickness of 10 μm or less.

3. The pressure-sensitive adhesive layer-attached polarizing film according to claim 1, wherein the pressure sensitive adhesive composition contains 0.005 to 2 parts by weight of the antioxidant based on 100 parts by weight of the (meth)acryl-based polymer.

4. The pressure-sensitive adhesive layer-attached polarizing film according to claim 1, wherein the pressure-sensitive adhesive composition contains a crosslinking agent.

5. The pressure-sensitive adhesive layer-attached polarizing film according to claim 4, wherein the pressure-sensitive adhesive composition contains a peroxide as the crosslinking agent.

6. The pressure-sensitive adhesive layer-attached polarizing film according to claim 4, wherein the pressure-sensitive adhesive composition contains an isocyanate crosslinking agent as the crosslinking agent.

7. The pressure-sensitive adhesive layer-attached polarizing film according to claim 4, wherein the pressure-sensitive adhesive composition contains 0.01 to 20 parts by weight of the crosslinking agent based on 100 parts by weight of the (meth)acryl-based polymer.

8. The pressure-sensitive adhesive layer-attached polarizing film according to claim 1, wherein the antioxidant is a phenolic antioxidant.

9. The pressure-sensitive adhesive layer-attached polarizing film according to claim 1, wherein the (meth)acryl-based polymer contains monomer units derived from an alkyl(meth)acrylate and hydroxyl group-containing monomer.

10. The pressure-sensitive adhesive layer-attached polarizing film according to claim 1, wherein the (meth)acryl-based polymer contains monomer units derived from an alkyl(meth)acrylate and carboxyl group-containing monomer.

11. The pressure-sensitive adhesive layer-attached polarizing film according to claim 1, wherein the (meth)acryl-based polymer has a weight average molecular weight of 500,00 to 3,000,000.

12. The pressure-sensitive adhesive layer-attached polarizing film according to claim 1, wherein the pressure-sensitive adhesive composition further contains 0.001 to 5 parts by weight of a silane coupling agent based on 100 parts by weight of the (meth)acryl-based polymer.

13. An image display device comprising at least one piece of the pressure-sensitive adhesive layer-attached polarizing film according to claim 1.
